(19) United States
(12) Patent Application Publication
(10) Pub. No.: US 2014/0007636 A1
(43) Pub. Date: Jan. 9, 2014

(54) LONG LIFE PINION SHAFT AND METHOD FOR MANUFACTURING THEREOF

(71) Applicants: HYUNDAI MOTOR COMPANY, Seoul (KR); KIA MOTORS CORPORATION, Seoul (KR)

(72) Inventor: Min-Woo Kang, Gunpo (KR)

(73) Assignees: KIA MOTORS CORPORATION, Seoul (KR); HYUNDAI MOTOR COMPANY, Seoul (KR)

(21) Appl. No.: 13/715,631

(22) Filed: Dec. 14, 2012

(30) Foreign Application Priority Data
Jul. 4, 2012 (KR) 10-2012-72608

(51) Int. Cl. B21C 23/00

(52) U.S. Cl. CPC F16C 3/02; B21C 23/007
USPC 72/60

(57) ABSTRACT

Disclosed is a long life pinion shaft having improved durability by forming an outer diameter portion thereof with high carbon alloy steel and the inner diameter portion medium carbon steel. In particular, the high carbon alloy steel, is selected from the group consisting of: high carbon chromium bearing steel; high speed tool steel; alloy tool steel; and/or carbon alloy steel.

### CROSS-REFERENCE TO RELATED APPLICATIONS

This application claims priority under 35 U.S.C. §119 to Korean Patent Application No. 10-2012-72608, filed on Jul. 4, 2012, in the Korean Intellectual Property Office, the disclosure of which is incorporated herein by reference in its entirety.

### BACKGROUND OF THE INVENTION

1. Field of the Invention

The present invention relates to a pinion shaft and a method for manufacturing thereof, more particularly, to a pinion shaft inserted into the middle of a pinion gear and combined with a carrier. The pinion shaft has improved durability (“long life”), which is provided, in particular, by forming the outer diameter portion of the pinion shaft of a high carbon alloy steel comprising some additive atoms, and the inner diameter portion of the pinion shaft of a medium carbon steel.

2. Description of the Related Art

Planetary gears are generally a gear system comprising a pair of gears engaged with each other, such that each of the two gears rotate respectively while one gear(s) revolves around the axis of the other gear.

These planetary gears are mainly used in a gear transmission apparatus for an automatic transmission of construction machines or vehicles, and they generally include: a sun gear; a ring gear concentrically arranged about the sun gear; two or more pinion gears, which are in engagement with the sun gear and the ring gear, and which revolve around the sun gear; and a carrier, which is concentrically arranged about the sun gear and the ring gear and supports rotation of the pinion gear.

Further, a pinion shaft which is in connection with the carrier, is inserted through the middle of the pinion gear. A needle bearing consisting of plural rolling elements is further installed between the pinion gear and the pinion shaft. The needle bearing refers to a bearing using thin and long cylindrical rollers.

Herein, the pinion shaft plays a role of supporting the pinion gear. As such, high dimensional stability, high durability and long life are required. Generally heat treatment using bearing steel is carried out to fabricate the pinion shaft. During the heat treatment process, a martensite structure and a retained austenite structure are formed inside of the material.

Through frequent use of the pinion shaft, the dimensions thereof change. This dimensional change through use of the pinion shaft is caused by a gradual volume expansion thereof as the retained austenite contained in the material is decomposed by external force and heat. This is an unavoidable phenomenon as long as austenite exists in the material.

In particular, because the pinion shaft is fixed to the carrier without any rotation therebetween, force such as centrifugal force is applied thereto toward a specific direction as the carrier revolves. As a result, the pinion shaft can be bent by local decomposition of the retained austenite, i.e., volume expansion.

When the pinion shaft is bent, uneven contact between the needle bearing and the pinion shaft results in the generation of edge load. This can result in damage to and peeling of the surface of the pinion shaft.

While reducing the amount of the retained austenite contained in the material may prevent bending of the pinion shaft, the retained austenite is an essential structure for the pinion shaft because it improves durability and prolongs life by providing tenacity to the material and suppressing crack growth for contact fatigue.

Based on an analysis of the correlation between the amount of the retained austenite and the life of the pinion shaft, it has been found that the smaller the amount of the retained austenite in the deep part of the pinion shaft and the larger the amount of the retained austenite in the outer layer of the pinion shaft, the longer the life of the pinion shaft.

On the basis of this correlation, many approaches for extending the life of the pinion shaft by improving durability thereof have been studied. One proposed method involves the application of multiple heat treatment processes so as to provide the outer layer with 15%˜40% retained austenite, and minimize the amount of the retained austenite of the deep part of the pinion shaft.

However, this method has problems of low productivity due to the complicated manufacturing processes, and further raises production costs.

In addition to the need to overcome the bending problem of the pinion shaft, the pinion shaft must also be fabricated of a high durability material. However, the bearing steel which has been used for the pinion shaft does not satisfy these need. This is particularly due to the requirements in the vehicle industry to manufacture light weight and high fuel efficiency vehicles, having miniaturized and high performance automatic transmissions, and which use low viscosity of transmission oil.

Accordingly, materials added with silicon, nickel, molybdenum, vanadium and the like have been proposed to improve strength and durability. However, this approach raises production costs due to the use of these expensive additive atoms.

The description provided above as a related art of the present invention is just for helping understanding the background of the present invention and should not be construed as being included in the related art known by those skilled in the art.

### SUMMARY OF THE INVENTION

The present invention provides a pinion shaft having a more durable life (longer life) and a method for its manufacturing. In particular, the present invention secures durability and dimensional stability, and at the same time, suppresses bending of the pinion shaft, by forming an outer diameter portion of the pinion shaft with high carbon alloy steel and forming an inner diameter portion of the pinion shaft with medium carbon steel. Preferably, the entire outer diameter portion (outer layer, along the entire length of the pinion shaft) is formed of the high carbon alloy steel, and the entire inner diameter portion (inner layer, along the entire length of the pinion shaft) is formed of the medium carbon steel. However, it is also possible, while not preferable, to form only a portion of the outer diameter portion and/or the inner diameter portion of the specified materials (e.g. by forming the inner diameter portion with medium carbon steel along only a portion of the pinion shaft's length).

According to embodiments of the present invention, a pinion shaft and a method for manufacturing thereof is provided which increases processing efficiency of oil holes and the like and reduces production costs at the same time by forming the inner diameter portion of the pinion shaft with medium carbon steel. The present invention further maintains low material costs even though atoms may be added for improving the durable life by applying a hydrostatic extrusion step and a single heat treatment step to a manufacturing process.

The technical problems to be solved by the present invention are not limited to the above technical problems and those skilled in the art may understand other technical problems from the following description.

According to one aspect, the present invention provides a long life pinion shaft which is combined with a carrier and inserted through the middle of a pinion gear. The pinion shaft is formed having an outer diameter portion formed of high carbon alloy steel, and an inner diameter portion formed of medium carbon steel.

According to various embodiments, the high carbon alloy steel is made from any one or more materials selected from the group consisting of: high carbon chromium bearing steel such as SUJ1, SUJ2, SUJ3, SUJ4 and SUJ5; high speed tool steel such as SKH2, SKH3, SKH4, SKH10 and SKH51 to SKH59; alloy tool steel such as SKS2, SKS3, SKS4, SKS5, SKS7, SKS8, SKS11, SKS21, SKS31, SKS41, SKS43, SKS44, SKS51, SKS93, SKS94, SKS95, SKD1, SKD11 and SKD12; and carbon alloy steel comprising about 0.8˜1.3% by weight carbon, about 0.5˜2.0% by weight manganese, about 1.0˜3.0% by weight silicon, about 0.5˜3.0% by weight chromium, about 0.3˜2.0% by weight nickel, about 0.05˜0.3% by weight molybdenum and about 0.05˜1.0% by weight vanadium.

According to an exemplary embodiment, the medium carbon steel comprises about 0.45% by weight to about 0.55% by weight carbon.

According to another aspect, the present invention provides a method for manufacturing a long life pinion shaft for insertion through the middle of a pinion gear, comprising the following steps of: inserting a medium carbon steel round bar into a high carbon alloy steel pipe, followed by welding and sealing to form a billet; hydrostatically extruding the billet for joining the materials thereof (medium and high carbon materials)under high temperature and high pressure; spheroidizing annealing the hydrostatically extruded billet; cutting and processing the annealed billet; heat treating the cut and processed billet; and polishing the heat treated billet to form a pinion shaft.

According to an exemplary embodiment, the heat treatment step is a single heat treatment via quenching or carbonitriding the cut and processed billet followed by tempering thereof.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 are plane views of the planetary gears and the pinion gear according to an embodiment of the present invention.

FIG. 2 is a cross-sectional view of the pinion gear according to an embodiment of the present invention.

FIG. 3 is a graph showing the correlation between the amount of retained austenite and the durable life of the pinion shaft.

FIG. 4 is a perspective view of the long life pinion shaft according to an embodiment of the present invention.

FIG. 5 is a flowchart showing steps for manufacturing the long life pinion shaft according to an embodiment of the present invention.

FIG. 6 is an exemplary view showing hydrostatic extrusion according to an embodiment of the present invention.

### DESCRIPTION OF SYMBOLS

100: Planetary Gears

110: Sun Gear

120: Ring Gear

200: Pinion Gear

210: Needle Bearing

300: Pinion Shaft

310: Outer Diameter Portion

320: Inner Diameter Portion

330: Oil Hole

400: Billet

410: High Carbon Alloy Steel Pipe

420: Medium Carbon Steel Round Bar

A: Load Area

B: Centrifugal Force

C: Desired Area of the Present Invention

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE EMBODIMENTS

Hereinafter, the preferred embodiment of the present invention now will be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

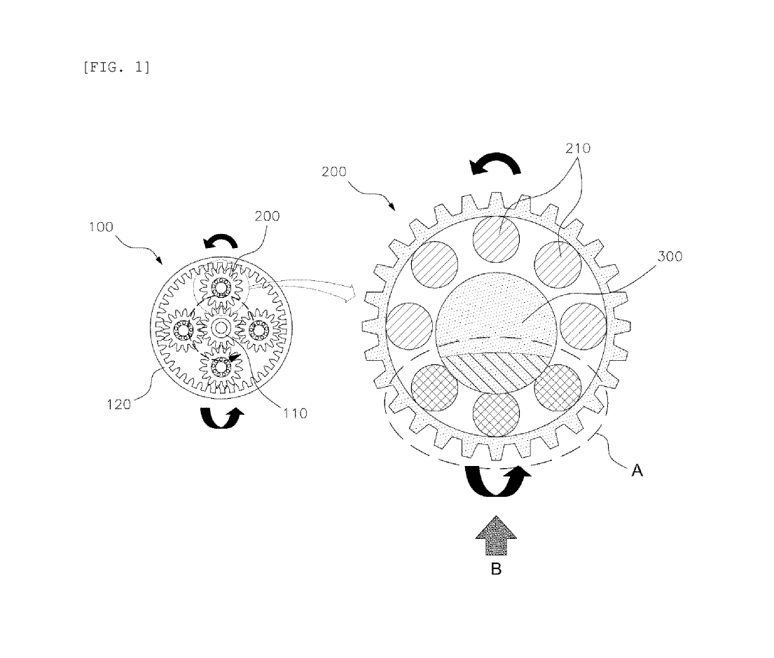

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.
FIG. 1 show plane views of the planetary gears and the pinion gear according to an embodiment of the present invention. In particular, the left portion of FIG. 1 shows planetary gears 100 which comprise: a sun gear 110; a ring gear 120 concentrically arranged about the sun gear 110; and two or more pinion gears 200, which are engaged with the sun gear 110 and the ring gear 120 and which are configured to revolve around the sun gear 110. In this drawing, four pinion gears 200 were illustrated. However, it is to be understood that any other number of pinion gears 200 could suitably be used in the present invention.

These planetary gears 100 comprise a gear system configured such that one gear revolves around the axis of the another gear. Planetary gears are mainly applied in a gear transmission apparatus for an automatic transmission, particularly in construction machines and vehicles.

The right portion of FIG. 1 shows a pinion gear 200. The pinion gear 200 is in engagement with the sun gear 110 and the ring gear 120 through mating teeth along their outer circumferences, and revolves around the sun gear 110.

As shown in FIG. 1, the pinion gear 200 comprises: a pinion shaft 300, which is disposed in the middle thereof, and a needle bearing 210, which is disposed around circumference of the pinion shaft 300.

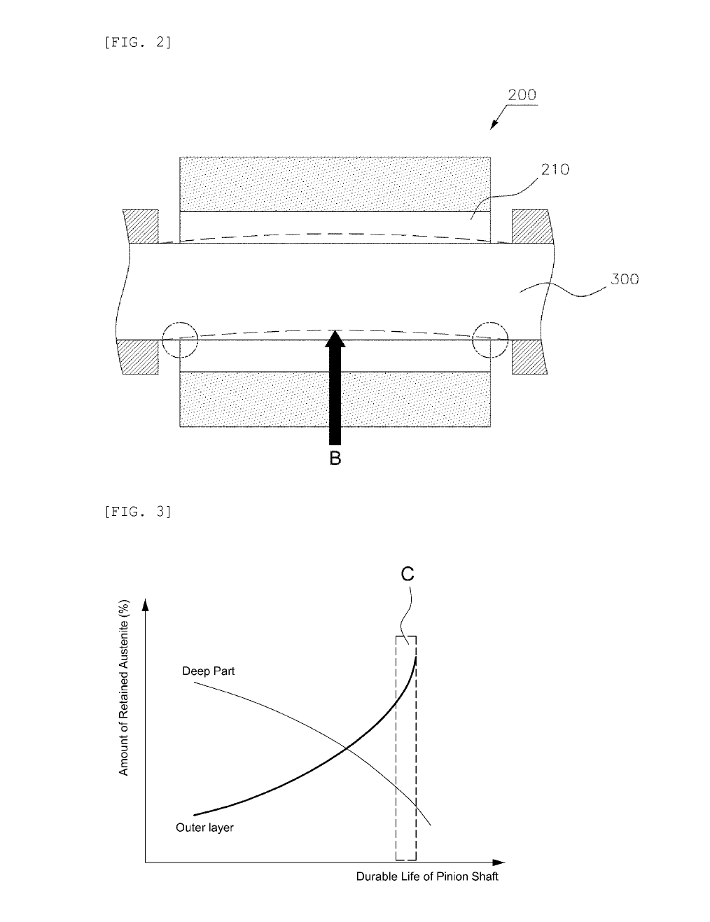

Herein, the pinion shaft 300 plays a role of supporting the pinion gear 200. According to conventional methods, the pinion shaft 300 is formed such that a martensite structure and a retained austenite structure are formed in the material thereof during heat treatment. This retained volume of austenite expands during use as it is decomposed by external force and heat. Namely, because the pinion shaft 300 is not fixed to the carrier during rotation, centrifugal force B (see FIGS. 1 and 2) is generated by revolution of the carrier, and volume expansion is generated as the retained austenite decomposes. As a result, the pinion shaft 300 bends.

In such conventional pinion shafts, a load area A is locally formed where external force is applied to a portion of the pinion shaft 300 and the needle bearing 210 around that portion.

FIG. 2 is a cross-sectional view of the pinion gear 200 according to one embodiment of the present invention. The dotted lines depict how a conventional pinion shaft typically bends through use. In particular, when external force (i.e., centrifugal force B) is locally applied to the load area A of a conventional pinion shaft, the volume of the retained austenite of the pinion shaft is expanded by decomposition of the retained austenite. This results in bending of the pinion shaft. FIG. 3 is a graph showing a correlation between the amount of retained austenite and the durable life of a pinion shaft.

As shown in FIG. 3, the smaller the amount of the retained austenite in the deep part of the pinion shaft 300 and the larger the amount of the retained austenite in the outer layer of the pinion shaft 300, the longer the life of the pinion shaft 300.

Accordingly, an area “C” of the graph depicts the desired area of the present invention, wherein the amount of the retained austenite is small in the deep part of the pinion shaft 300 and is large in the outer layer of the pinion shaft 300.

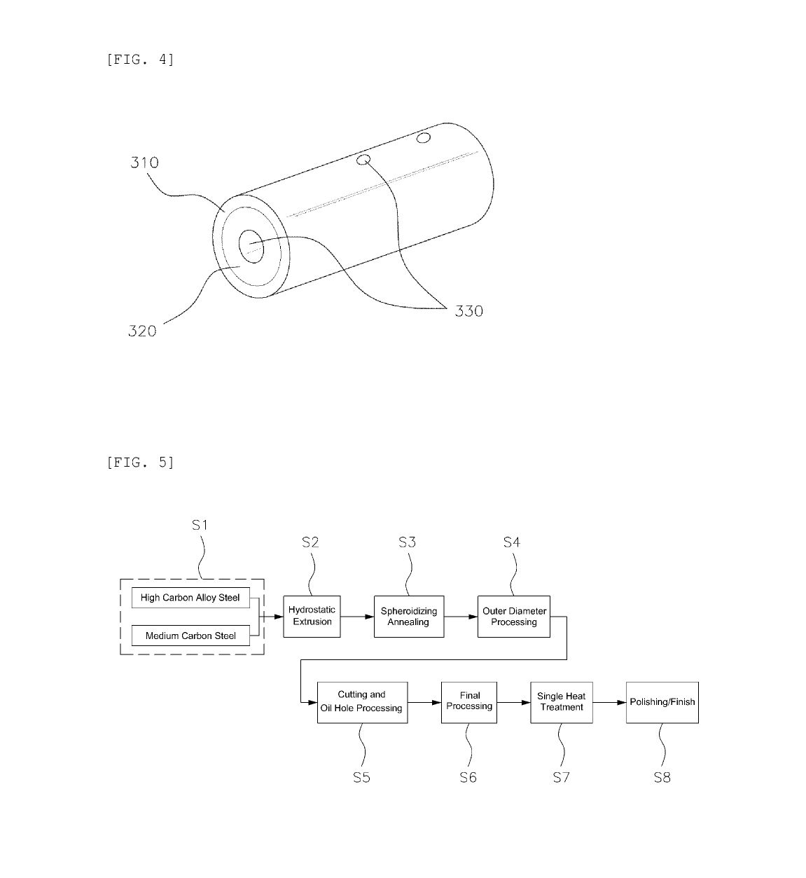

FIG. 4 is a perspective view of the long life pinion shaft according to one embodiment of the present invention.

According to the present invention, in order to control the amount of the retained austenite so as to prolong the life of the pinion shaft 300, the outer diameter portion 310 of the pinion shaft 300 is made from high carbon alloy steel; and the inner diameter side 320 of the pinion shaft 300 is made from medium carbon steel. According to embodiments of the present invention, the high carbon alloy steel may comprise one or more material selected from the group consisting of: carbon, silicon, manganese, phosphorus, sulfur, chromium, nickel, molybdenum, vanadium and tungsten. By providing the pinion shaft 300 with this structure and composition, durability of the pinion shaft 300 is improved.

Further, according to embodiments of the present invention, rolling contact fatigue performance is improved by forming the outer diameter portion 310 of the pinion shaft 300 with a high carbon alloy steel, which further comprises additive atoms for improving durability. According to the present invention, durability of the pinion shaft 300 is improved while minimizing the increase in material costs.

As referred to herein, the high carbon alloy steel which is used as a material in forming the outer diameter portion 310 can be m any one or more materials selected from the group consisting of: high carbon chrome bearing steel, such as SUJ1, SUJ2, SUJ3, SUJ4 and SUJ5; high speed tool steel, such as SKH2, SKH3, SKH4, SKH10 and SKH51 to SKH59; alloy tool steel, such as SKS2, SKS3, SKS4, SKS5, SKS7, SKS8, SKS11, SKS21, SKS31, SKS41, SKS43, SKS44, SKS51, SKS93, SKS94, SKS95, SKD1, SKD11 and SKD12; and carbon alloy steel comprising about 0.8˜1.3% by weight carbon, about 0.5˜2.0% by weight manganese, about 1.0˜3.0% by weight silicon, about 0.5˜3.0% by weight chrome , about 0.3˜2.0% by weight nickel, about 0.05˜0.3% by weight molybdenum and about 0.05˜1.0% by weight vanadium.

The SUJ is high carbon chromium bearing steel, and its JIS standards No. is G4805.

The SUJ1 is high carbon chromium bearing steel comprising about 0.95˜1.10% by weight carbon, about 0.15˜0.35% by weight silicon, about 0.50% by weight or less manganese, about 0.025% by weight or less phosphorus, about 0.025% by weight or less sulfur, about 0.90˜1.20% by weight chromium, about 0.08% by weight or less molybdenum, about 0.025% by weight or less copper and about 0.025% by weight or less nickel. It is noted that the % by weight noted above, when referring to a % by weight “or less” refers generally to an amount greater than zero % by weight.

The SUJ2 is high carbon chromium bearing steel comprising about 0.95˜1.10% by weight carbon, about 0.15˜0.35% by weight silicon, about 0.50% by weight or less manganese, about 0.025% by weight or less phosphorus, about 0.025% by weight or less sulfur, about 1.30˜1.60% by weight chromium, about 0.08% by weight or less molybdenum, about 0.025% by weight or less copper and about 0.025% by weight or less nickel. Again, it is noted that the % by weight noted above, when referring to a % by weight “or less” refers generally to an amount greater than zero % by weight.

The SUJ3 is high carbon chromium bearing steel comprising about 0.95˜1.10% by weight carbon, about 0.40˜0.70% by weight silicon, about 0.90˜1.15% by weight manganese, about 0.025% by weight or less phosphorus, about 0.025% by weight or less sulfur, about 0.90˜1.20% by weight chromium, about 0.08% by weight or less molybdenum, about 0.025% by weight or less copper and about 0.025% by weight or less nickel. Again, it is noted that the % by weight noted above, when referring to a % by weight “or less” refers generally to an amount greater than zero % by weight.

The SUJ4 is high carbon chromium bearing steel comprising about 0.95˜1.10% by weight carbon, about 0.15˜0.35% by weight silicon, about 0.50% by weight or less manganese, about 0.025% by weight or less phosphorus, about 0.025% by weight or less sulfur, about 1.30˜1.60% by weight chromium, about 0.10˜0.25% by weight molybdenum, about 0.025% by weight or less copper and about 0.025% by weight or less nickel. Again, it is noted that the % by weight noted above, when referring to a % by weight “or less” refers generally to an amount greater than zero % by weight.

The SUJ5 is high carbon chromium bearing steel comprising about 0.95˜1.10% by weight carbon, about 0.40˜0.70% by weight silicon, about 0.90˜1.15% by weight manganese, about 0.025% by weight or less phosphorus, about 0.025% by weight or less sulfur, about 0.90˜1.20% by weight chromium, about 0.10˜0.25% by weight molybdenum, about 0.025% by weight or less copper and about 0.025% by weight or less nickel. Again, it is noted that the % by weight noted above, when referring to a % by weight “or less” refers generally to an amount greater than zero % by weight.

As the further materials which may be used in forming the outer diameter portion 310, the SKH is a high speed tool steel having JIS standard No. of G4403, and the SKS and the SKD are alloy tool steel having JIS standard No. of G4404. All of the SKH, SKS and SKD are characterized by comprising carbon of about 0.75% by weight or more, with a balance of chromium, nickel, molybdenum, tungsten and vanadium.

It is also possible to add other atoms beside the atoms listed above. However, it is preferred to add the atoms in an amount of about 0.25% by weight or less. While it is possible not to add the atoms (and thus provide 0% by weight) it is preferable that the amount of atoms is greater than 0% by weight.

According to embodiments of the present invention, the inner diameter portion 320 of the pinion shaft 300 is formed with medium carbon steel. This reduces the amount of the retained austenite in the deep part of the pinion shaft 300 and, thereby, suppresses deformation. In addition, by using the medium carbon steel material, the efficiency for processing oil holes 330 and the like can be improved and the production costs can be reduced.

Herein, it is preferred that the medium carbon steel which is used as the material of the inner diameter portion 320 comprises about 0.45% by weight to about 0.55% by weight carbon.

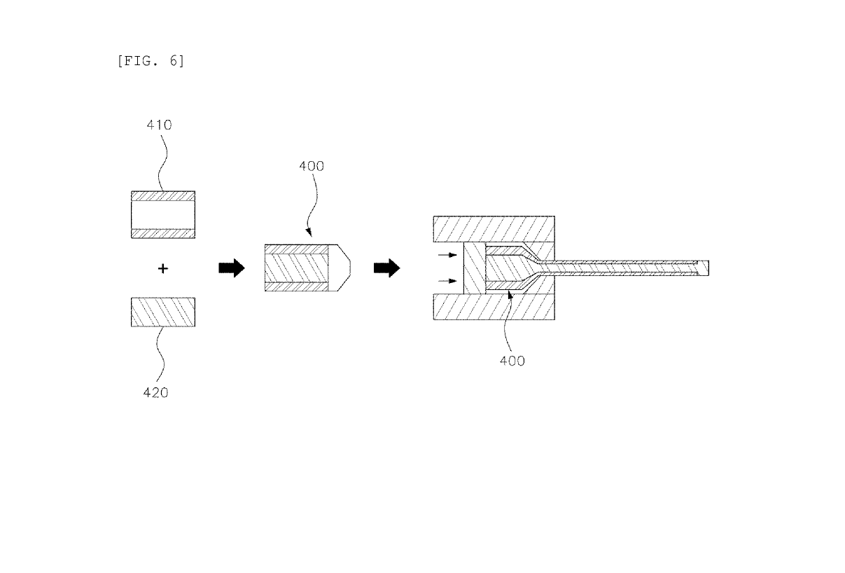

FIG. 5 is a flow chart showing steps for manufacturing the long life pinion shaft 300 according to one embodiment of the present invention.

As depicted, the method comprises the following steps of: inserting a medium carbon steel round bar 420 into a high carbon alloy steel pipe 410, followed by welding and sealing to form a billet 400 S1; hydrostatically extruding the billet 400 for joining the materials thereof under high temperature and high pressure S2; spheroidizing annealing the hydrostatically extruded billet 400 S3; cutting and processing the annealed billet 400 S4, S5, S6; heat treating the cut and processed billet 400 S7; and polishing the heat treated billet 400 to form a pinion shaft 300 S8.

As shown in FIG. 6, the medium carbon steel round bar 420 is inserted into the high carbon alloy steel pipe 410, followed by welding and sealing therefor to form the billet 400 S1. As referred to herein, the billet 400 refers to flat steel before rolling thereof to section steel, and is a material that is subsequently hydrostatically extruded in the present invention.

Then, the billet 400 formed with the materials described herein are hydrostatically extruded for joining thereof (in particular, for joining the portion formed of the medium carbon steel round bar and the portion formed of the high carbon alloy steel pipe; i.e. for joining the medium carbon steel and high carbon steel) under high temperature and high pressure S2. The hydrostatic extrusion is generally a process of pressurizing a container of a certain type and size containing metal materials under high pressure, and extruding out the materials. Hydrostatic extrusion has an effect on preventing decrease of interfacial strength between the materials. Hydrostatic extrusion according to one embodiment of the present invention is shown in FIG. 6. It is noted that hydrostatic extrusion is well-known in the art, and, thus, the details thereof will not be further described herein.

Then, spheroidizing annealing is conducted S3. Annealing is generally a process in which the metal materials are heated to a proper temperature, followed by slowly cooling thereof to room temperature. This process removes internal residual stress of the hardened materials by processing or quenching and the like, and increase softness thereof by refining grains. Further, spheroidizing is a process in which the carbides in the steel are changed to a ball shape. When steel is subjected to spheroidizing annealing, its tenacity increases, its processability improves and its performance as a tool is enhanced.

According to various embodiments, the spheroidizing annealing step S3 can be omitted depending on the desired end results.

The treated billet 400 is then cut and processed. According to the depicted embodiment, the processing step comprises oil hole 330 formation, lathe processing, cutting processing and drill processing S4, S5, S6.

After cutting and processing, the billet is heat treated. As shown in the exemplary embodiment, the heat treatment o is a single heat treatment S7 via quenching or carbonitriding, followed by tempering. This is in contrast with a conventional combined heat treatment via quenching or carbonitriding, tempering, high frequency heat treatment followed by tempering. By applying the single heat treatment according to the exemplary embodiment, the manufacturing process can be simplified and the production costs can be reduced. Through this heat treatment, the retained austenite of about 20˜40% can be formed on the surface (an outer portion) of the pinion shaft 300.

Finally, the heat treated billet 400 can be is polished to complete the manufacture of the pinion shaft 300 S8.

Durability of the long life pinion shaft 300 as prepared by the exemplary embodiment of the present invention was tested, and the results are as follows.

A cylinder based rolling contact fatigue test was carried out, in which contact stress was 5.88 GPa, test speed was 46,240 times/min, and test lubricating oil was turbine oil VG56. As a result, durability was increased by at least three that of conventional pinion shafts. In particular, a conventional pinion shaft made from SUJ2 demonstrated a B₁₀ life of 6.3×10⁷ cycles, while the pinion shaft according to the present invention made demonstrated a B₁₀ life of 18.5×10⁷ cycles. (B₁₀ life: life of reliability 90%)

The pinion shaft 300 of the present invention, wherein the outer diameter portion 310 thereof is formed with high carbon alloy steel (to which atoms may be further added for improving durability) and the inner diameter portion 320 thereof is formed with medium carbon steel, advantageously of provides a prolonged durable life by securing durability and dimensional stability and by suppressing bending.

Further, the present invention improves processing efficiency, simplifies the manufacturing process, and reduces the material costs and the production costs thereof.

The present invention provides an improved pinion shaft having an outer diameter portion formed with high carbon alloy steel which may include added atoms for improving durability, and an inner diameter portion formed with medium carbon steel, and which has an improved durable life. In particular, the present invention secures the durability and dimensional stability of the pinion shaft, and further suppresses bending because a small amount of the retained austenite is formed in the deep (inner) part of the pinion shaft and a larger amount of the retained austenite is formed on the outer portion/layer of the pinion shaft.

Further, the present invention improves rolling contact fatigue performance by forming the outer diameter portion of the pinion shaft with high carbon alloy steel, and increases processing efficiency of oil holes and the like by forming the inner diameter portion of the pinion shaft with medium carbon steel. Further, the present invention provides for high interfacial strength between the materials forming the inner and outer diameter portions.

The present invention further reduces the material costs and the production costs of the pinion shaft by forming the inner diameter portion with medium carbon steel, which is a relatively cheap material, and by using a hydrostatic extrusion step and single heat treatment step in the manufacturing process.

The invention has been described in detail with reference to preferred embodiments thereof. However, it will be appreciated by those skilled in the art that changes or modifications may be made in these embodiments without departing from the principles and spirit of the invention, the scope of which is defined in the appended claims and their equivalents.

What is claimed is:

1. A pinion shaft for insertion through a middle of a pinion gear in combination with a carrier, the pinion shaft comprising:
an outer diameter portion made from high carbon alloy steel; and
an inner diameter portion made from medium carbon steel.

2. The long life pinion shaft according to claim 1, wherein the high carbon alloy steel is selected from one or more materials selected from the group consisting of: high carbon chromium bearing steel; high speed tool steel; alloy tool steel; and carbon alloy steel.

3. The long life pinion shaft according to claim 1, wherein the high carbon chromium bearing steel is selected from the group consisting of SUJ1, SUJ2, SUJ3, SUJ4 and/or SUJ5; the high speed tool steel is selected from the group consisting of SKH2, SKH3, SKH4, SKH10 and/or SKH51 to SKH59; the alloy tool steel is selected from the group consisting of SKS2, SKS3, SKS4, SKS5, SKS7, SKS8, SKS11, SKS21, SKS31, SKS41, SKS43, SKS44, SKS51, SKS93, SKS94, SKS95, SKD1, SKD11 and/or SKD12; and the carbon alloy steel comprises about 0.8˜1.3% by weight carbon, about 0.5˜2.0% by weight manganese, about 1.0˜3.0% by weight silicon, about 0.5˜3.0% by weight chromium, about 0.3˜2.0% by weight nickel, about 0.05˜0.3% by weight molybdenum and about 0.05˜1.0% by weight vanadium.

4. The long life pinion shaft according to claim 1, wherein the medium carbon steel comprises about 0.45% by weight to 0.55% by weight carbon.

5. A method for manufacturing a pinion shaft for inserted through a middle of a pinion gear comprising the steps of:
disposing a medium carbon steel round bar within a high carbon alloy steel pipe, followed by welding and sealing to form a billet;
hydrostatically extruding the billet so as to join the medium carbon steel round bar and high carbon alloy steel pipe under high temperature and high pressure;
spheroidizing annealing the billet;
cutting and processing the billet;
heat treating the billet; and
polishing the billet to form a pinion shaft.

6. The method according to claim 5, wherein the heat treatment step is a single heat treatment via quenching or carbonitriding followed by tempering.
